(19) United States
(12) Patent Application Publication
(10) Pub. No.: US 2010/0321932 A1
(43) Pub. Date: Dec. 23, 2010

(54) LED LAMP STRING DEVICE IN WHICH THE LED LAMP ASSEMBLIES HAVE ROUGHLY THE SAME SHINING LUMINANCE, AND ITS REALIZING METHOD

(76) Inventor: Kwo Kiun George Tong, Hong Kong (CN)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/835,150

(22) Filed: Jul. 13, 2010

Related U.S. Application Data
(63) Continuation of application No. 12/016,546, filed on Jan. 18, 2008, now abandoned.

(30) Foreign Application Priority Data
Jan. 19, 2007 (CN) 200710072993.3

(51) Int. Cl. F21V 9/00; F21S 4/00

(52) U.S. Cl. 362/231; 362/249.06

(57) ABSTRACT

A LED lamp string device in which the LED lamp assemblies have roughly the same shining luminance, and its realizing method, based on the said LED lamp string device comprising a plurality of LED lamp assemblies and a power supply module, make decorative covers using different material that have different transparency based on the different luminance classes, let the rate of transparency of said decorative cover correspond with the above-mentioned light-emitting luminance class of said LED luminous bodies based on the inverse relation; Put said decorative covers onto suitable LED luminous bodies respectively based on the said inverse relation so as to make LED lamp assemblies covered with suitable translucent decorative hoods have roughly the same shining luminance. The current invention overcomes shortcoming of ragged luminance of LED luminous body in LED lamp assemblies, and enhances beauty of said LED lamp string assemblies; enriching colors of light emitted by said LED lamp string device; if LED lamp string device use LED luminous bodies having the same electrical specifications, the abnormal damage problem of the above LED luminous bodies also can be avoided effectively.

### TECHNICAL FIELD

The present invention relates to decorative lighting installation comprises a plurality of light source. More particularly, the present invention relates to the lamp string device using luminous element of semiconductor for decorative lighting.

### BACKGROUND ART

LED lamp string device for decorative lighting at prior art comprises LED lamp assemblies, decorative covers and a power supply module. The color of light emitted by said LED lamp assembly depend on LED luminous body, and said LED luminous bodies of different colors have different rated voltage values and rated current values, e.g., rated voltage value of white light LED luminous body is 3.6V and rated current value is 3 mA; rated voltage value of red light LED luminous body is 2V and rated current value is 2 mA. The said LED lamp string device of the prior art make said LED luminous bodies work under their rated values by connected resistors in parallel with said LED luminous bodies. The said LED lamp string device of the prior art have the following shortcomings:

1. The said LED lamp luminous bodies work normally under rated voltage value and luminance of said LED lamp luminous bodies in different colors is different, making users have a feeling that such LED lamp string device is ragged or imperfect, thus negatively affecting decorative effects of said LED lamp string device;

2. The color of light emitted by said LED lamp assembly depend on LED luminous body, however, owing to restriction by manufacturing technology, kind of color of light emitted by said LED luminous body is limited, which is unable to emit some special color. For example, product of the prior art do not contain LED luminous body that can generate brown light, leading to the fact that said LED lamp string device can only generate monotonous colors.

### Summary of the Current Invention

The technical problem that the current invention aims to solve is to avoid shortcomings of the prior art and to provide a method and a LED lamp string device to enable the shining luminance of LED lamp assemblies of LED lamp string device to be roughly the same with the aid of respective decorative covers, and enrich colors of light emitted by said LED lamp device.

The said technical problem can be resolved by this invention via adopting the following technical solution:

Adopt a method to enable the shining luminance of LED lamp assemblies of LED lamp string device to be roughly the same with the aid of respective decorative covers, based on the said LED lamp string device comprising LED lamp assemblies and a power supply module, said method comprising the steps of:

a) Let LED luminous bodies of different colors which are mounted in said LED lamp assemblies, be lighted normally under their rated conditions, and evaluate their luminance respectively, and sum their luminance up as difference levels of the brightest, brighter, bright and inadequately bright;

b) Define the corresponding relation between said luminance of LED luminous bodies of different colors and the color of light emitted by the LED luminous bodies, based on the above-mentioned different luminance levels of the brightest, brighter, bright and inadequately bright;

c) Make decorative covers using different materials that have different transparency, and let the rate of transparency of said decorative covers correspond with the above-mentioned light-emitting luminance level of said LED luminous bodies;

d) Put said decorative covers onto suitable LED luminous bodies respectively based on the inverse relation between said transparency of the decorative covers and the luminance of said luminous bodies, i.e. the decorative covers with higher transparency are put onto the LED luminous bodies with lower luminance level, and the decorative covers with lower transparency are put onto the LED luminous bodies with higher luminance level so as to make LED lamp assemblies covered with suitable decorative covers have roughly the same shining luminance.

The said materials of said decorative covers in step c) are colorless and/or milk white, or colored. If said materials of said decorative covers are colored, respective decorative covers can be made from different colored translucent materials, or all decorative covers can be made from translucent materials in the same color. The said respective decorative covers are made in different geometrical shapes in three-dimensional and/or planar, including hollow globe, hollow cylinder, hollow cone or round disc with a central hole.

To avoid the losses of electric energy and prolong the service life of said LED luminous bodies, all LED lamp assemblies in said LED lamp string device have LED luminous bodies of the same electrical specifications, i.e. the same rated voltage value and rated current value, the same power, even the same color and luminance of light emitted by the LED luminous bodies.

The said power supply module is a battery box containing batteries, said battery include primary and secondary battery; or it can be a adapter, including a industrial frequency transformer and a switching power supply, i.e. an electronic transformer; it can be also a line powered directly from utility circuit, including a fuse and an air overload switch in series.

The said technical problem can be resolved by this invention further via adopting the following technical solution:

Manufacture a LED lamp string device enabling the shining luminance of its LED lamp assemblies to be roughly the same with the aid of respective decorative covers, comprising LED lamp assemblies and a power supply module; the LED lamp assembly constituting said LED lamp string device comprising decorative cover, LED luminous body and lamp base, the rate of transparency of said decorative covers correspond with the light-emitting luminance class of said LED luminous bodies, said decorative covers are put onto suitable LED luminous bodies respectively based on the inverse relation between said transparency of the decorative covers and the luminance of said luminous bodies, i.e. the decorative covers with higher transparency are put onto the LED luminous bodies with lower luminance, and the decorative covers with lower transparency are put onto the LED luminous bodies with higher luminance so as to make LED lamp assemblies covered with suitable decorative covers have roughly the same shining luminance.

The said decorative covers are made from colorless and/or milk white translucent materials, or colored translucent materials. If said decorative covers are made from colored translucent materials, respective decorative covers can be made from different colored translucent materials, or all decorative covers can be made from translucent materials in the same color. The said respective decorative covers are made in different geometrical shapes in three-dimensional and/or planar, including hollow globe, hollow cylinder, hollow cone or round disc with a central hole.

All LED lamp assemblies in said LED lamp string device have LED luminous bodies of the same electrical specifications, i.e. the same rated voltage value and rated current value, the same power, even the same color and luminance of light emitted by the LED luminous bodies, which avoiding the losses of electric energy owing to the resistors in parallel with said LED luminous bodies and prolonging the actual service life of LED luminous bodies.

Compared with the existing technology, the current invention “A LED lamp string device in which the LED lamp assemblies have roughly the same shining luminance, and its realizing method” has technical advantages as the following:

1. Using decorative covers on LED lamp assemblies to change their luminance of light emitted in order for roughly the same shining luminance overcomes shortcoming of LED lamp string device of the prior art, i.e., ragged luminance of LED luminous body in LED lamp assemblies, and enhances beauty of said LED lamp string assemblies;

2. Color of light emitted by said LED lamp assemblies with decorative covers depends on said decorative covers; different colors of translucent materials of said decorative covers lead to different colors of said LED lamp assemblies, which are not limited only to original color of light emitted by said luminous bodies, thus enriching colors of light emitted by said LED lamp string device;

3. If LED lamp assemblies in said LED lamp string device use LED luminous bodies in the same electrical specifications, it is not necessary to use resistors in parallel or in series to let LED luminous bodies work under their rated values, which solving the problem of electric energy losses owing to such resistors in parallel or in series and the electric energy is saved; in practical applications, the LED luminous bodies of different specifications are connected in series, and some of said LED luminous bodies can not be lighted before their service life is reached and abnormal damage accidents occur; if said LED lamp string assemblies use LED luminous bodies of the same specifications in series, abnormal damage problem of the above LED luminous bodies can be avoided effectively and actual service life of LED luminous bodies is prolonged to a great extent.

### BRIEF DESCRIPTION OF DRAWINGS

FIG. 1 is the front view of a sketch of preferred embodiment of the current invention “A LED lamp string device in which the LED lamp assemblies have roughly the same shining luminance, and its realizing method”;

FIG. 2 is an axonometric projection sketch of LED lamp assembly 1 of LED lamp string device; FIG. 3 is an exploded view of said LED lamp assembly 1;

FIG. 4 is a cross-section of decorative cover 11.

### DETAILED DESCRIPTION OF THE PREFERRED EMBODIMENT

An elaborated illustration based on the preferred embodiments as shown in the attached figures is provided as follows.

This invention relates to a method to enable the shining luminance of LED lamp assemblies of LED lamp string device to be roughly the same with the aid of respective decorative covers, based on the said LED lamp string device comprising LED lamp assemblies and a power supply module, said method comprising the steps of:

a) Let LED luminous bodies of different colors which are mounted in said LED lamp assemblies, be lighted normally under their rated conditions, and evaluate their luminance respectively, and sum their luminance up as difference levels of the brightest, brighter, bright and inadequately bright;

b) Define the corresponding relation between said luminance of LED luminous bodies of different colors and the color of light emitted by the LED luminous bodies, based on the above-mentioned different luminance levels of the brightest, brighter, bright and inadequately bright;

c) Make decorative covers using different materials that have different transparency, and let the rate of transparency of said decorative covers correspond with the above-mentioned light-emitting luminance level of said LED luminous bodies;

d) Put said decorative covers onto suitable LED luminous bodies respectively based on the inverse relation between said transparency of the translucent decorative hoods and the luminance of said luminous bodies, i.e. the decorative covers with higher transparency are put onto the LED luminous bodies with lower luminance, and the decorative covers with lower transparency are put onto the LED luminous bodies with higher luminance so as to make LED lamp assemblies covered with suitable decorative covers have roughly the same shining luminance.

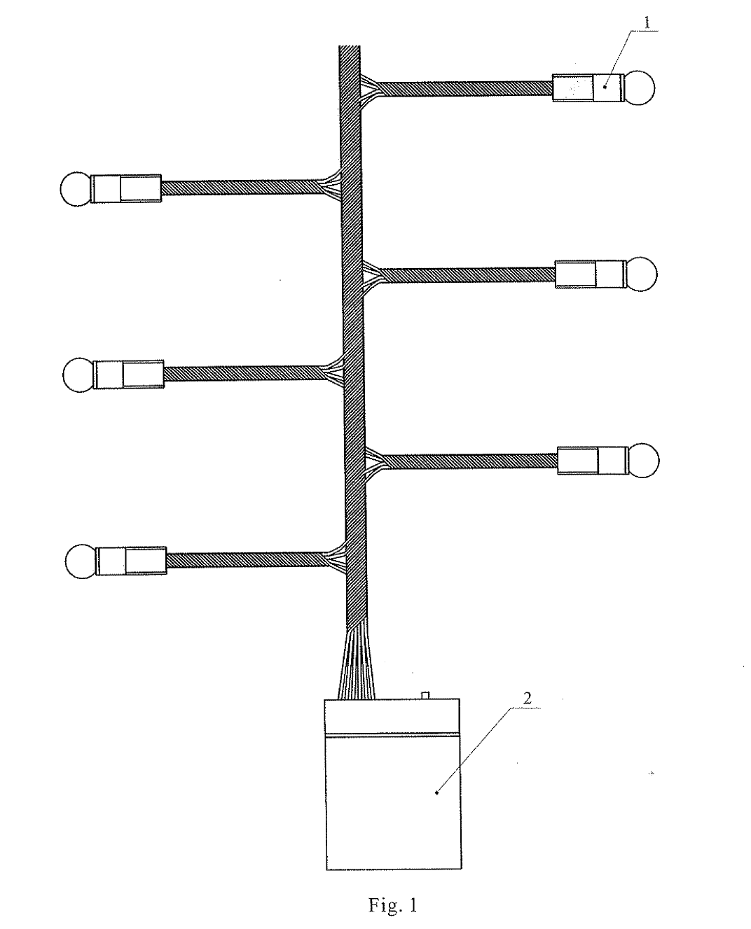

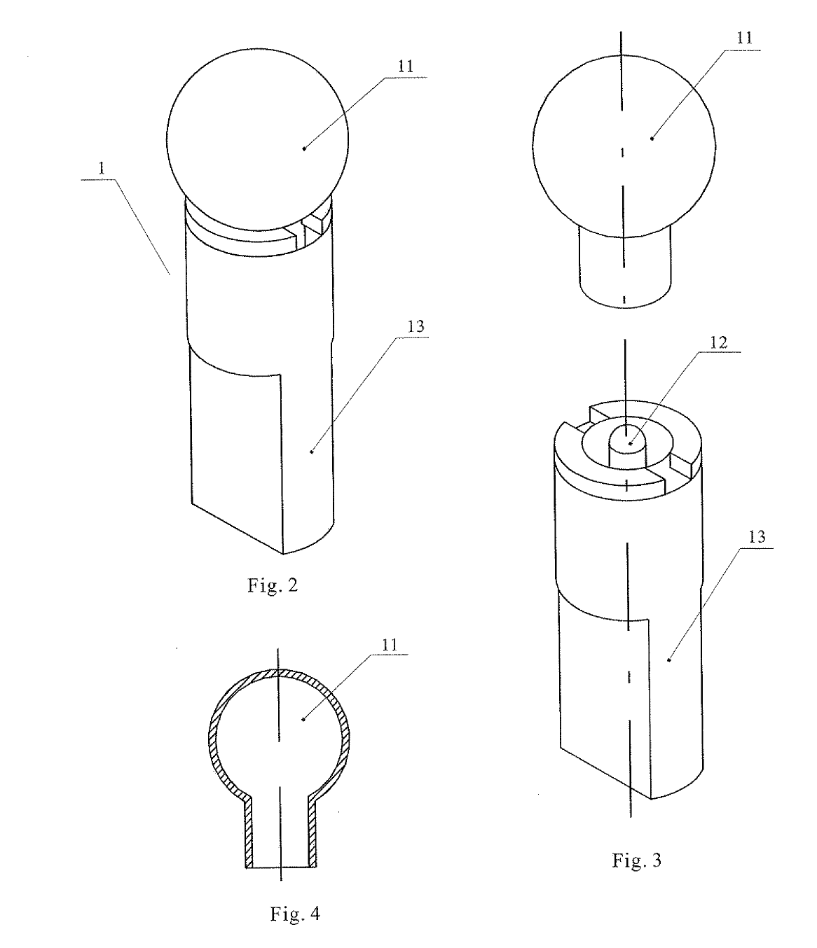

This invention also relates to a LED lamp string device enabling the shining luminance of its LED lamp assemblies to be roughly the same with the aid of respective decorative covers which is manufactured by the above-mentioned method, showed as from FIG. 1 to FIG. 2, comprising LED lamp assemblies 1 and a power supply module 2; the LED lamp assembly 1 constituting said LED lamp string device comprising decorative cover 11, LED luminous body 12 and lamp base 13, the rate of transparency of said decorative covers 11 correspond with the light-emitting luminance class of said LED luminous bodies 12, said decorative covers 11 are put onto suitable LED luminous bodies 12 respectively based on the inverse relation between said transparency of the decorative covers 11 and the luminance of said luminous bodies 12, i.e. the decorative covers 11 with higher transparency are put onto the LED luminous bodies 12 with lower luminance, and the decorative covers 11 with lower transparency are put onto the LED luminous bodies 12 with higher luminance so as to make LED lamp assemblies 1 covered with suitable decorative covers 11 have roughly the same shining luminance.

Said LED lamp string device in the preferred embodiment of the current invention is shown in FIG. 1, which comprises LED lamp assemblies 1 and a power supply module 2. As shown in FIG. 2 and FIG. 3, the LED lamp assembly 1 comprising decorative cover 11, LED luminous body 12 and lamp base 13; Said LED luminous bodies 12 includes red LED luminous bodies 12, yellow LED luminous bodies 12 and blue LED luminous bodies 12. The following steps are adopted to realize the current invention “A method to enable the shining luminance of LED lamp assemblies of LED lamp string device to be roughly the same with the aid of respective decorative covers”:

a) Let said red LED luminous bodies 12, yellow LED luminous bodies 12 and blue LED luminous bodies 12 be lighted normally under their rated conditions and evaluate their lighting luminance respectively, the result that evaluating the lighting of said LED luminous bodies 12 does not need the accurate Batas of measure, in the preferred embodiment of the current invention, the said evaluation is watching with eyes. By the said evaluation with eyes, sum luminance of light emitted by respective LED luminous bodies 12 up as difference levels of the brightest, brighter, and inadequately bright.

b) Based on the above-mentioned different luminance levels, define the corresponding relation between said luminance of LED luminous bodies of different colors and the color of light emitted by the LED luminous bodies. For example, based on the different luminance classes, define luminance classes of said yellow LED luminous bodies 12 is the brightest, luminance classes of said red LED luminous bodies 12 is brighter, luminance classes of said blue LED luminous bodies 12 is inadequately bright;

c) Make decorative covers 11 using different material that have different transparency, and let the rate of transparency of said decorative cover 11 correspond with the above-mentioned light-emitting luminance level of said LED luminous bodies 12 based on the inverse relation. In the preferred embodiment of the current invention, manufacture three kinds of translucent decorative hoods 11 respectively using different material that have different transparency of high, middling, and low, said decorative cover 11 made from material that have high transparency correspond with said blue LED luminous bodies 12 whose luminance level is inadequately bright; said decorative cover 11 made from material that have middling transparency correspond with said red LED luminous bodies 12 whose luminance level is brighter; said decorative cover 11 made from material that have low transparency correspond with said yellow LED luminous bodies 12 whose luminance level is the brightest.

d) Put said decorative covers 11 onto suitable LED luminous bodies 12 respectively based on the inverse relation between said transparency of the decorative covers 11 and the luminance of said luminous bodies 12, i.e. the decorative covers 11 with higher transparency are put onto the LED luminous bodies 12 with lower luminance, and the decorative covers 11 with lower transparency are put onto the LED luminous bodies 12 with higher luminance so as to make LED lamp assemblies 1 covered with suitable decorative covers 11 have roughly the same shining luminance. In the preferred embodiment of the current invention, put said decorative cover onto suitable LED luminous bodies 12 respectively based on the corresponding relation of the above-mentioned step c), said decorative covers 11 with high transparency are put onto said blue LED luminous bodies 12 whose luminance classes is inadequately bright to maintain luminance of LED lamp assembly 1; said decorative covers 11 with low transparency are put onto said yellow LED luminous bodies 12 whose luminance classes is the brightest to reduce luminance of LED lamp assembly 1; said decorative covers 11 with middling transparency are put onto said red LED luminous bodies 12 whose luminance classes is brighter to reduce luminance of LED lamp assembly 1 to an appropriate degree. Hence, said LED lamp assemblies 1 covered with suitable decorative covers 11 have roughly the same shining luminance.

Said LED lamp string device manufactured by the above-mentioned method enable the shining luminance of its LED lamp assemblies I to be roughly the same with the aid of respective decorative cover 11, overcomes shortcoming of LED lamp string device of the prior art, i.e., ragged luminance of LED luminous bodies in LED lamp assemblies, and enhances beauty of said LED lamp string assemblies.

The materials of said decorative covers in step c) are colorless and/or milk white, or colored. If said translucent materials are colored, respective decorative covers 11 can be made from different colored translucent materials, or all decorative covers 11 can be made from translucent materials in the same color. If colorless transparent materials are used to make said decorative covers 11, then color of light emitted by LED luminous bodies 12 are that generated by said LED lamp assemblies 1; if transparent materials in the same color are used to make said decorative cover 11, not only the shining luminance of LED lamp assemblies 1 change, but also the colors of light emitted by the LED lamp assemblies 1 change, the colors of light emitted by said LED lamp assemblies 1 are decided by said LED luminous bodies 12 and decorative covers 11, which are not limited only to original color of light emitted by said luminous bodies 12; if colored transparent materials are used to make said decorative covers 11, the colors of light emitted by said LED lamp assemblies 1 enrich greatly. The shining luminance and colors of light emitted by said LED lamp assemblies 1 are decided by said decorative covers 11, said LED lamp string device can be designed in multiple and flexible color patterns. In the preferred embodiment of the current invention, respective decorative covers 11 are made from different colored translucent materials,

Particularly, all LED lamp assemblies I in said LED lamp string device have LED luminous bodies 12 of the same electrical specifications, i.e. the same rated voltage value and rated current value, the same power, even the same color and luminance of light emitted by the LED luminous bodies 12. In the preferred embodiment of the current invention, all LED luminous bodies 12 are white and high luminance. All LED lamp assemblies 1 have LED luminous bodies 12 of the same electrical specifications, because respective LED luminous bodies 12 have the same rated values, it is not necessary to use resistors in parallel with each LED luminous bodies 12, the problem of electric energy losses owing to such resistors in parallel is solved and luminance of all the LED luminous bodies 12 is identical. In the preferred embodiment of the current invention, said LED lamp string device have LED luminous bodies 12 of the same electrical specifications and colored decorative covers 11, not only enable shining luminance of LED lamp assemblies 1 to be roughly the same, but also create better effects in both energy-saving and enriching colors of light emitted by said LED lamp assemblies 1. In actual practices, said LED luminous bodies 12 of different electrical specifications are connected in series in LED lamp string device, and resistors are connected in parallel to each LED luminous bodies 12 to balance current, and some of said LED luminous bodies 12 can not be lighted before their service life is reached and abnormal damage accidents occur, especially red and green LED light emitters. If said LED lamp string assemblies use LED luminous bodies 12 of the same electrical specifications in series, it is easier to enable luminance of respective LED lamp assemblies 1 to be roughly the same, and it is not necessary to use resistors in parallel, which avoiding the losses of electric energy. At the same time, abnormal damage problem of the above LED light emitters can be avoided effectively and actual service life of LED light emitters is prolonged to a great extent.

The said respective decorative covers 11 are made in different geometrical shapes in three-dimensional and/or planar, including hollow globe, hollow cylinder, hollow cone or round disc with a central hole. As shown in FIG. 2, FIG. 3 and FIG. 4, in the preferred embodiment of the current invention, the said decorative covers 11 are made in hollow globe. If LED lamp string device comprises various three-dimensional and/or planar shaped translucent decorative hoods 11, decoration effects of said LED lamp string device will be enhanced very much.

The said LED lamp string device can adapt all kinds of power supply system. The said power supply module 2 is a battery box containing batteries, said battery include primary and secondary battery; or said power supply module 2 can be a adapter, including a industrial frequency transformer and a switching power supply, i.e. an electronic transformer; said power supply module 2 can be also a line powered directly from utility circuit, including a fuse and an air overload switch in series. In the preferred embodiment of the current invention, as shown in FIG. 1, said power supply module 2 is a battery box containing batteries, said battery is secondary battery.

The current invention “A LED lamp string device in which the LED lamp assemblies have roughly the same shining luminance, and its realizing method” overcomes shortcoming of LED lamp string device of the prior art, i.e., ragged luminance of LED luminous body in LED lamp assemblies, and enhances beauty of said LED lamp string assemblies; enriching colors of light emitted by said LED lamp string device; if LED lamp string device use LED luminous bodies in the same specification in series, the abnormal damage problem of the above LED luminous bodies also can be avoided effectively.

What is claimed is:

1. A method to enable the shining luminance of LED lamp assemblies of LED lamp string device to be roughly the same with the aid of respective decorative covers, based on the said LED lamp string device comprising LED lamp assemblies and a power supply module, said method comprising the steps of:
a) Let LED luminous bodies of different colors which are mounted in said LED lamp assemblies, be lighted normally under their rated conditions, and evaluate their luminance respectively, and sum their luminance up as difference levels;
b) Define the corresponding relation between said luminance of LED luminous bodies of different colors and the color of light emitted by the LED luminous bodies, based on the above-mentioned different luminance levels;
c) Make decorative covers using different materials that have different transparency, and let the rate of transparency of said decorative covers correspond with the above-mentioned light-emitting luminance levels of said LED luminous bodies;
d) Put said decorative covers onto suitable LED luminous bodies respectively based on the inverse relation between said transparency of the decorative covers and the luminance of said luminous bodies, i.e. the decorative covers with higher transparency are put onto the LED luminous bodies with lower luminance, and the decorative covers with lower transparency are put onto the LED luminous bodies with higher luminance so as to make LED lamp assemblies covered with suitable decorative covers have roughly the same shining luminance.

2. A method to enable the shining luminance of LED lamp assemblies of LED lamp string device to be roughly the same with the aid of respective translucent decorative hoods as set forth in claim 1, wherein said the materials of the decorative covers in step c) are colorless and/or milk white.

3. A method to enable the shining luminance of LED lamp assemblies of LED lamp string device to be roughly the same with the aid of respective decorative covers as set forth in claim 1, wherein said translucent materials in step c) are colored, said respective decorative covers are made from different colored translucent materials or all decorative covers are made from translucent materials in the same color.

4. A method to enable the shining luminance of LED lamp assemblies of LED lamp string device to be roughly the same with the aid of respective decorative covers as set forth in claim 1, wherein said respective decorative covers are made in different geometrical shapes in three-dimensional and/or planar, including hollow globe, hollow cylinder, hollow cone or round disc with a central hole.

5. A method to enable the shining luminance of LED lamp assemblies of LED lamp string device to be roughly the same with the aid of respective decorative covers as set forth in claim 1, wherein all LED lamp assemblies in said LED lamp string device have LED luminous bodies of the same electrical specifications.

6. A method to enable the shining luminance of LED lamp assemblies of LED lamp string device to be roughly the same with the aid of respective decorative covers as set forth in claim 1, wherein said power supply module is a battery box containing batteries, said battery include primary and secondary battery.

7. A method to enable the shining luminance of LED lamp assemblies of LED lamp string device to be roughly the same with the aid of respective decorative covers as set forth in claim 1, wherein said power supply module is a adapter, including a industrial frequency transformer and a switching power supply, i.e. an electronic transformer.

8. A method to enable the shining luminance of LED lamp assemblies of LED lamp string device to be roughly the same with the aid of respective decorative covers as set forth in claim 1, wherein said power supply module is a line powered directly from utility circuit, including a fuse and an air overload switch in series.

9. A LED lamp string device enabling the shining luminance of its LED lamp assemblies to be roughly the same with the aid of respective decorative covers, comprising LED lamp assemblies and a power supply module; wherein the LED lamp assembly constituting said LED lamp string device comprising decorative cover, LED luminous body and lamp base, the rate of transparency of said decorative covers correspond with the light-emitting luminance level of said LED luminous bodies, said decorative covers are put onto suitable LED luminous bodies respectively based on the inverse relation between said transparency of the decorative covers and the luminance of said luminous bodies, i.e. the decorative covers with higher transparency are put onto the LED luminous bodies with lower luminance, and the decorative covers with lower transparency are put onto the LED luminous bodies with higher luminance so as to make LED lamp assemblies covered with suitable decorative covers have roughly the same shining luminance.

10. A LED lamp string device enabling the shining luminance of its LED lamp assemblies to be roughly the same with the aid of respective decorative covers as set forth in claim 9, wherein said decorative covers are made from colorless and/or milk white translucent materials.

11. A LED lamp string device enabling the shining luminance of its LED lamp assemblies to be roughly the same with the aid of respective decorative covers as set forth in claim 9, wherein said decorative covers are made from colored translucent materials, said respective decorative covers are made from different colored translucent materials or all decorative covers are made from translucent materials in the same color.

12. A LED lamp string device enabling the shining luminance of its LED lamp assemblies to be roughly the same with the aid of respective decorative covers as set forth in claim 9, wherein said respective decorative covers are made in different geometrical shapes in three-dimensional and/or planar, including hollow globe, hollow cylinder, hollow cone or round disc with a central hole.

13. A LED lamp string device enabling the shining luminance of its LED lamp assemblies to be roughly the same with the aid of respective decorative covers as set forth in claim 9, wherein all LED lamp assemblies in said LED lamp string device have LED luminous bodies of the same electrical specifications.

14. A LED lamp string device enabling the shining luminance of its LED lamp assemblies to be roughly the same with the aid of respective decorative covers as set forth in claim 9, wherein said power supply module is a battery box containing batteries, said battery include primary and secondary battery.

15. A LED lamp string device enabling the shining luminance of its LED lamp assemblies to be roughly the same with the aid of respective decorative covers as set forth in claim 9, wherein said power supply module is a adapter, including a industrial frequency transformer and a switching power supply, i.e. an electronic transformer.

16. A LED lamp string device enabling the shining luminance of its LED lamp assemblies to be roughly the same with the aid of respective decorative covers as set forth in claim 9, wherein said power supply module is a line powered directly from utility circuit, including a fuse and an air overload switch in series.
